(19) United States
(12) Patent Application Publication
(10) Pub. No.: US 2004/0266975 A1
(43) Pub. Date: Dec. 30, 2004

(54) Polycarbonate moldings

(76) Inventors: Jurgen Rohner, Koln (DE); Siegfried Anders, Koln (DE); Rudiger Gorny, Moon Twp., PA (US); Peter Schwarz, Krefeld (DE)

Correspondence Address: BAYER MATERIAL SCIENCE LLC, 100 BAYER ROAD, PITTSBURGH, PA, 15205, US

(21) Appl. No.: 10/828,981

(22) Filed: Apr. 21, 2004

(30) Foreign Application Priority Data
Apr. 25, 2003 (DE) 10318739.1

(51) Int. Cl. C08G 64/00

(52) U.S. Cl. 528/196

(57) ABSTRACT

A thermally-formed molded article comprising a branched polycarbonate having improved thickness uniformity is disclosed. The polycarbonate has a melt volume rate of 1.5 to 10 and a viscosity parameter of 1.75 to 3.0. Also disclosed is a process for the production of the article.

The invention relates to molded articles and more particularly to articles comprising branched polycarbonate resin.

### SUMMARY OF THE INVENTION

A thermally-formed molded article comprising a branched polycarbonate having improved thickness uniformity is disclosed. The polycarbonate has a melt volume rate of 1.5 to 10 and a viscosity parameter of 1.75 to 3.0. Also disclosed is a process for the production of the article.

### BACKGROUND OF THE INVENTION

Polycarbonate moldings, such as, for example, polycarbonate corrugated sheets or polycarbonate thermoformed moldings, are as a rule produced from linear polycarbonate on special solid sheet installations with subsequent forming devices.

Production takes place in the first step in a sheet die and in the nip of a polishing calender, as a result of which a solid sheet is produced.

In this procedure, polycarbonate granules are fed to an extruder and melted in the plasticating system of the extruder. The molten plastic is forced through a sheet die, brought into the desired shape in the nip of a polishing calender and fixed in shape by alternate cooling on polishing rolls and in the ambient air. The polycarbonates of high melt viscosity used for the extrusion are conventionally processed at melt temperatures of 260 to 320° C., and the barrel temperatures of the plasticating barrel and the die temperatures are set accordingly.

In a second production step, the solid sheet produced in this way is heated again inline or offline and formed into moldings, such as, for example, corrugated sheets or thermoformed moldings, in a forming device. In the case of corrugated sheets, the forming devices may comprise, for example, fixed profile strips or movable profile rolls. Conventional corrugation geometries for corrugated sheets are, for example, sinusoidally (“Roma”) or trapezoidally (“Greca”) corrugated profiles.

In the case of thermoformed moldings, shaping is carried out with the aid of a suitable tool, the forming taking place due to mechanical forces and/or vacuum, compressed air or a combination thereof.

In both the cases mentioned, the sheet is often stretched non-uniformly during forming, which leads to undesirable differences in thickness, thus, for example, thinning in the side regions, or even to constrictions, in particular, for example, in the comer regions of the molding. An increased production of waste and a higher consumption of materials are the consequence.

WO 00/26287 A1 discloses flameproofed sheets, which may also be corrugated, comprising a branched PC, a phosphorus flameproofing agent and a mold release agent. The branched PC has an MVR (at 300° C., 2.16 kg) of>11 cm³/10 min. However, the thickness uniformity of formed sheets is not mentioned.

WO 01/66615 A1 discloses solid shaped articles (sheets) of a branched polycarbonate. However, here also the thickness uniformity of formed sheets is not mentioned.

The object on which the invention is based was therefore to provide polycarbonate moldings formed by hot-formiing which have an improved thickness uniformity and allow a lower consumption of materials.

It has been found, surprisingly, that this object is achieved by polycarbonate moldings which have been formed by hot-forming and comprise a branched polycarbonate. By using such a branched polycarbonate described in more detail below, a more uniform stretching during forming and therefore the desired improved thickness uniformity may be achieved.

### BRIEF DESCRIPTION OF THE DRAWING

The FIGURE shows a formed molding.

### DETAILED DESCRIPTION OF THE INVENTION

The present invention therefore provides polycarbonate moldings formed by hot-forming comprising a branched polycarbonate, characterized in that the branched polycarbonate has a melt volume rate (MVR at 300° C. under a load of 1.2 kg in accordance with ISO 1133) of 1.5 to 10, preferably 2.0 to 8, particularly preferably 2.5 to 7, and a viscosity parameter of 1.75 to 3.0, preferably 1.78 to 2.7, particularly preferably 1.8 to 2.5.

The viscosity parameter is defined in this context as the melt viscosity in Pa*s at a shear rate of 100/s at 300° C. divided by the melt viscosity in Pa*s at a shear rate of 1,000/s at 300° C., in each case measured in accordance with DIN54811-B.

The polycarbonate moldings according to the invention formed by hot-forming are, for example, moldings produced by thermoforming, such as, for example, lamp covers, dome lights or motor vehicle windscreens, or polycarbonate corrugated sheets produced by corrugation.

The polycarbonate moldings according to the invention formed by hot-forming are preferably polycarbonate corrugated sheets.

The present invention furthermore provides a process for the production of polycarbonate moldings formed by hot-forming which have an improved thickness uniformity, comprising the steps

I. production of a solid sheet comprising a branched polycarbonate with a melt volume rate (MVR at 300° C. under a load of 1.2 kg in accordance with ISO 1133) of 1.5 to 10, preferably 2.0 to 8, very particularly preferably 2.5 to 7, and a viscosity parameter of 1.75 to 3.0, preferably 1.78 to 2.7, particularly preferably 1.8 to 2.5,

II. heating of this solid sheet to the forming temperature above the glass transition temperature, but below the conventional processing temperature for extrusion of the polycarbonate employed, and

III. hot-forming of the heated sheet at this temperature by the action of mechanical forces, vacuum, compressed air or a combination thereof.

To produce the solid sheets (step I) by extrusion, the polycarbonate granules are as a rule fed to the hopper of an extruder and arrives via this in the plasticating system, comprising the screw and barrel.

The material is conveyed and melted in the plasticating system. The melt of plastic is forced through a sheet die. A filter device, a melt pump, stationary mixing elements and further components may be positioned between the plasticating system and the sheet die. The melt leaving the die arrives at a polishing calender. The final shaping takes place in the nip of the polishing calender. The shape is fmally fixed by cooling, and in particular alternately on the polishing rolls and in the ambient air. Further devices serve for transportation, application of protective film, cutting into lengths and stacking of the extruded sheets.

In the case of coextrusion (herein coex), the material to be coextruded is plasticated in the same manner in one or more further extruders. The coex melt(s) is (are) brought together with the main material in a special coex adapter before the die or in a special coex die. The coex layer may be applied either to one side or to both sides of the base layer. Subsequent working of the sheets may take place by surface treatments, such as finishing with scratch-resistant coatings, water-spreading layers and other functional layers.

In the second production step (step II) the solid sheet produced is heated again inline or offline. For this, the sheet to be shaped is heated to the forming temperature e.g. by an infra-red lamp or a contact heater, optionally after an appropriate pretreatment (drying etc.).

For the process according to the invention, the forming temperature range for corrugation and thermoforming is above the glass transition temperature, but below the conventional processing temperature for extrusion of the polycarbonate employed.

The forming temperature range is preferably between 220° C. and 140° C., particularly preferably between 200° C. and 170° C.

In step III, the hot-forming is carried out with the aid of a suitable tool, the forming taking place due to mechanical forces, vacuum, compressed air or a combination thereof.

The hot-forming takes place, for example and preferably, by corrugation or thermoforming.

In the corrugation process, the solid sheet which has been heated to the forming temperature is formed into a corrugated sheet in a corrugating device. The corrugating device may comprise fixed profile strips, movable profile rolls—or a combination of the two. Movable rolls are preferably employed. Various geometries (size, shape and position of the corrugations) are possible for a corrugated sheet. The corrugation process as a rule is carried out continuously.

In the case of hot-forming by thermoforming, shaping is carried out with the aid of a suitable tool, wherein the forming takes place due to mechanical forces and/or vacuum, compressed air or a combination thereof and/or may be assisted by an additional punch. The tools employed may be constructed in this context as a positive or negative mold, depending on the requirements on the molding. The thermoforming is carried out discontinuously.

Branched polycarbonates which are suitable according to the invention may be prepared by known processes. Suitable processes for the preparation of polycarbonates are, for example, preparation from bisphenols with phosgene by the phase boundary process or from bisphenols with phosgene by the process in a homogeneous phase, the so-called pyridine process, or from bisphenols with carbonic acid esters by the melt transesterification process. The preparation processes are described, for example, in H. Schnell, “Chemistry and Physics of Polycarbonates”, Polymer Reviews, Volume 9, p. 31-76, Interscience Publishers, New York, London, Sydney, 1964. The preparation processes mentioned are also described in “Polycarbonates” in Encyclopedia of Polymer Science and Engineering, Volume 11, Second Edition, 1988, pages 648 to 718 and in “Polycarbonate” in Becker, Braun, Kunststoff-Handbuch, Volume 3/1, Polycarbonate, Polyacetale, Polyester, Celluloseester, Carl Hanser Verlag Munich, Vienna 1992, pages 117 to 299.

The melt transesterification process is described in particular in H. Schnell, “Chemistry and Physics of Polycarbonates”, Polymer Reviews, Volume 9, p. 44 to 51, Interscience Publishers, New York, Sydney, 1964 and in DE 1 031 512 A, U.S. Pat. Nos. 3,022,272, 5,340,905 and 5,399,659.

The branched polycarbonates employed according to the invention are either homopolycarbonates or copolycarbonates or mixtures thereof. The term polycarbonate as used in the present context embraces branched polycarbonates, branched polyester-carbonates and mixtures of the two.

The polycarbonates which are suitable according to the invention are branched in a known manner, and in particular preferably by the incorporation of branching agents which are trifinctional or more than trifunctional. Suitable branching agents are, for example, those with three or more phenolic groups, or those with three or more carboxylic acid groups.

Suitable branching agents are, for example, phloroglucinol, 4,6-dimethyl-2,4,6-tri(4-hydroxyphenyl)-hept-2-ene, 4,6-dimethyl-2,4,6-tri(4-hydroxyphenyl)-heptane, 1,3,5-tri-(4-hydroxyphenyl)-benzene, 1,1,1-tris-(4-hydroxyphenyl)-ethane, tri-(4-hydroxyphenyl)-phenylmethane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxyphenyl)-methane, tetra-(4-(4-hydroxy-phenyl-isopropyl)-phenoxy)-methane and 1,4-bis-(4′,4″-dihydroxytriphenyl)-methylbenzene as well as 2,4-dihydroxybenzoic acid, trimesic acid, cyanuric chloride, 3,3-bis-(3-methyl-4-hydroxyphenyl)-2-oxo-2,3-dihydroindole, trimesic acid trichloride and α,α′,α″-tris-(4-hydroxyphenyl)-1,3,5-triisopropylbenzene.

Preferred branching agents are 1,1,1-tris-(4-hydroxyphenyl)-ethane and 3,3-bis-(3-methyl-4-hydroxyphenyl)-2-oxo-2,3-dihydroindole.

The amount of branching agent optionally to be employed is preferably 0.05 to 0.6 mol %, preferably 0.1 to 0.5 mol %, based on the moles of bisphenol employed.

The average molecular weight of the polycarbonates to be used according to the invention may be adjusted, for example, in a known manner by an appropriate amount of chain terminators. The chain terminators may be employed individually or as a mixture of various chain terminators.

Both monophenols and monocarb oxylic acids are suitable chain terminators.

Suitable monophenols are e.g. phenol, p-chlorophenol, p-tert-butylphenol, cumylphenol or 2,4,6-tribromophenol as well as long-chain alkylphenols, such as 4-(1,1,3,3-tetramethylbutyl)-phenol, or monoalkylphenols or dialkylphenols with a total of 8 to 20 C atoms in the alkyl substituents, such as 3,5-di-tert-butylphenol, p-tert-octylphenol, p-dodecylphenol, 2-(3,5-dimethyl-heptyl)-phenol or 4-(3,5-dimethyl-heptyl)-phenol. Suitable monocarboxylic acids are benzoic acid, alkylbenzoic acids and halogenobenzoic acids.

The amount of chain terminator to achieve the desired molecular weight range in the phase boundary process is conventionally 2 to 4 mol % of chain terminator, based on the moles of the bisphenols used. In the case of preparation by the trans esterification process, the amount of chain terminator is such that the carbonic acid diester, for example diphenyl carbonate, is employed in excess in relation to the bisphenol for example 102 to 108 mol of diphenyl carbonate per 100 mol of bisphenol, depending on the distillation column used.

In a preferred embodiment, the polycarbonate employed is a polycarbonate based on bisphenol A, bisphenol TMC, 4,4′-dioxydiphenyl and mixtures thereof, particularly preferably bisphenol A and 0.05 to 0.6 mol %, preferably 0.1 to 0.5 mol %, very particularly preferably 0.2 to 0.4 mol % of a branching agent.

Further conventional additives may be admixed to the polycarbonate employed and/or applied to the surface. Conventional additives are, for example, UV stabilizers, mold release agents, fillers, reinforcing substances, stabilizers, such as heat stabilizers and γ-ray stabilizers, antistatics, flow auxiliaries, fireproofing agents, dyestuffs and pigments. The additives mentioned and further additives are described in Gächter, Müller, Kunststoff-Additive, 3rd Edition, Hanser-Verlag, Munich, Vienna, 1989.

Examples of antistatics are cationic compounds, for example quaternary ammonium, phosphonium or sulfoniurn salts, anionic compounds, for example alkyl sulfonates, alkyl sulfates, alkyl phosphates and carboxylates in the form of alkali metal or alkaline earth metal salts, and nonionic compounds, for example polyethylene glycol esters, polyethylene glycol ethers, fatty acid esters and ethoxylated fatty amines. Preferred antistatics are nonionic compounds.

Examples of suitable UV absorbers are:

a) Benzotriazole derivatives of the formula (I)

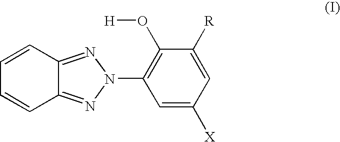

wherein in formula (I)

R and X are identical or different and are H or alkyl or alkylaryl.

b) Dimeric benzotriazole derivatives of the formula (II) or formula (III)

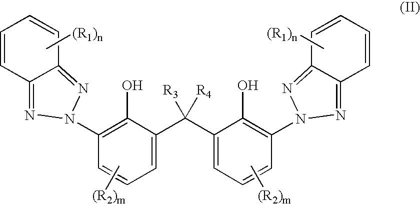

wherein in formula (II)

R¹ and R² are identical or different and denote H, halogen, C₁-C₁₀-alkyl, C₅-C₁₀-cycloalkyl, C₇-C₁₃-aralkyl, C₆-C14-aryl, —OR⁵ or —(CO)—O—R⁵ where R⁵═H or C₁-C₄-alkyl, R³ and R⁴ are likewise identical or different and denote H, C₁-C₄-alkyl, C₅-C₆-cycloalkyl, benzyl or C₆-C₁₄-aryl, m is 1, 2 or 3 and n is 1, 2, 3 or 4,

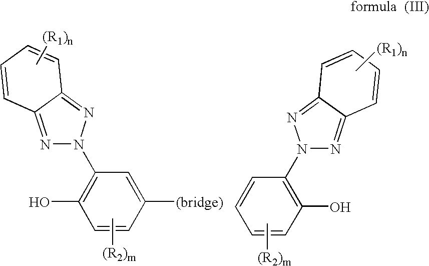

wherein in formula (III) bridge denotes

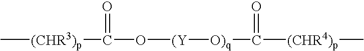

R¹, R², m and n have the meaning given for formula (II), wherein moreover p is an integer from 0 to 3, q is an integer from 1 to 10,

Y is —CH₂—CH₂—, —(CH₂)₃—, —(CH₂)₄—, —(CH₂)₅—, —(CH₂)₆— or

CH(CH₃)—CH₂— and R³ and R⁴ have the meaning given for formula (II);

c) Triazine derivatives of the formula (IV)

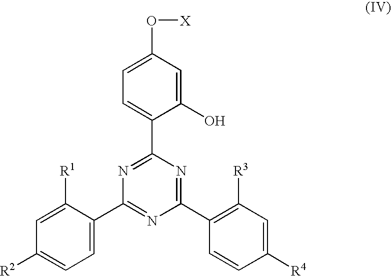

wherein in formula (IV)

R¹, R², R³, R⁴ are identical or different and are H or alkyl or CN or halogen and X=alkyl.

d) Triazine derivatives as disclosed in EP 1 033 243 A1

e) Dimeric triazine derivatives of the formula (V)

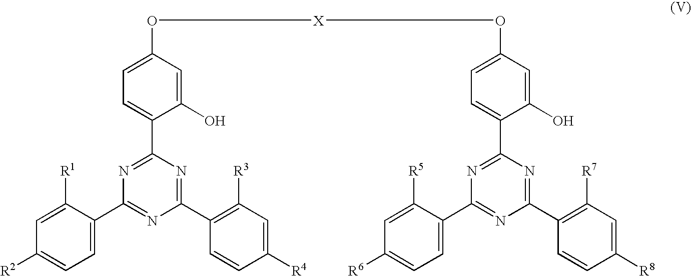

wherein in formula (V)

R¹, R², R³, R⁴, R⁵, R⁶, R⁷, R⁸ are identical or different and are H or alkyl or CN or halogen and X=alkyl or —(CH₂CH₂—O—)n-C(═O)—.

f) Diaryl cyanoacrylates of the formula (VI)

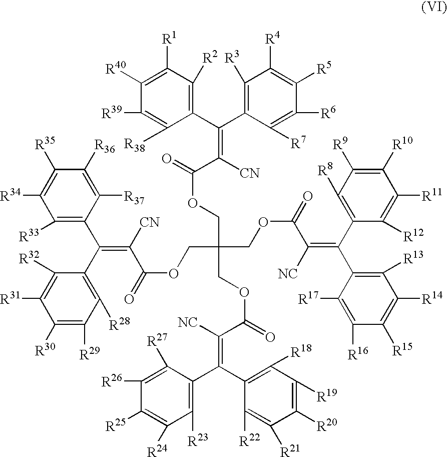

wherein in formula (VI)

R¹ to R⁴⁰ are identical or different and are H, alkyl, CN or halogen.

g) Diaryl cyanoacrylates of the formula (VII)

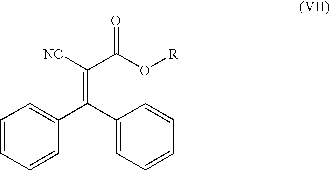

wherein in formula (VIII)

R is C₂-alkyl to C₁₀-alkyl or aryl.

Uvinul® 3035 (R═C₂H₅) and Uvinul® 3039 (R═CH₂CH(C₂H₅)C4H₉) are preferred in this context.

h) Hydroxybenzophenone derivatives of the formula (VIII)

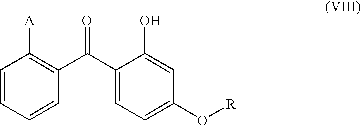

wherein in formula (VIII)

A is H or OH and

R is H, alkyl, acyl, —(CH₂)ₙ—O—(CH₂)ₙ—CH₃ or —(CH₂)ₙ—O—C(═O)—(CH₂)ₙ—CH₃, where n=1-20

i) Resorcinol derivatives of the formula (IX)

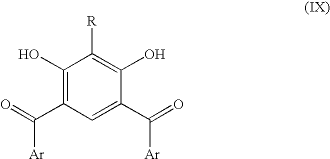

wherein in formula (IX)

Ar is phenyl, naphthyl, alkylphenyl or alkoxyphenyl and

R is H, alkyl, isoalkyl, cycloalkyl, acyl, —(CH₂)ₙ—O—(CH₂)ₙ—CH₃, —(CH₂)ₙ—O—C(═O)—(CH₂)ₙ—CH₃, —C(═O)—(CH₂)ₙ—CH₃ or —C(═O)—Ar, where n=1-20

j) Further resorcinol derivatives as disclosed in EP 846 673 A1 or in EP 854 127 A1.

All the layers of the shaped articles according to the invention may comprise one or more UV absorbers.

Suitable stabilizers are, for example, phosphines, phosphites or Si-containing stabilizers and further compounds described in EP 0 500 496 A1. Examples which may be mentioned are triphenylphosphine, diphenyl alkyl phosphites, phenyl dialkyl phosphites, tris-(nonylphenyl) phosphite, tetrakis-(2,4-di-tert-butylphenyl)-4,4′-biphenylene-diphosponite and triaryl phosphites. Triphenylphosphine, 2,4,6 tri-t-butylphenyl-2-butyl-2-ethyl-1,3-propanediol phosphite and tris-(2,4-di-tert-butylphenyl) phosphite are particularly preferred.

The shaped articles according to the invention may furthermore comprise mold release agents in a concentration of 0.01 to 1 wt. %, preferably 0.05 to 0.6 wt. %, based on the weight of the shaped article.

Suitable mold release agents are, for example, (partial) esters of mono- to hexahydric alcohols, in particular of glycerol, pentaerythritol or Guerbet alcohols.

Monohydric alcohols are, for example, stearyl alcohol, palmityl alcohol and Guerbet alcohols. A dihydric alcohol is, for example, glycol. A trihydric alcohol is, for example, glycerol. Tetrahydric alcohols are, for example, pentaerythritol and mesoerythritol. Pentahydric alcohols are, for example, arabitol, ribitol and xylitol. Hexahydric alcohols are, for example, mannitol, glucitol (sorbitol) and dulcitol.

The esters are the monoesters, diesters, triesters, tetraesters, where appropriate pentaesters and hexaesters or mixtures thereof, in particular statistical mixtures, of saturated, aliphatic C₁₀ to C₃₆-monocarboxylic acids and optionally hydroxy-monocarboxylic acids, preferably with saturated, aliphatic C₁₄ to C₃₂-monocarboxylic acids and optionally hydroxy-monocarboxylic acids.

The commercially obtainable fatty acid esters, in particular of pentaerythritol and glycerol, may contain<60% of various partial esters here as a result of their preparation.

Saturated, aliphatic monocarboxylic acids having 10 to 36 C atoms are, for example, capric acid, lauric acid, myristic acid, palmitic acid, stearic acid, hydroxystearic acid, arachic acid, behenic acid, lignoceric acid, cerotic acid and montan acids.

Preferred saturated, aliphatic monocarboxylic acids having 14 to 22 C atoms are, for example, myristic acid, palmitic acid, stearic acid, hydroxystearic acid, arachic acid and behenic acid.

Saturated, aliphatic monocarboxylic acids such as palmitic acid, stearic acid and hydroxystearic acid are particularly preferred. The saturated, aliphatic C₁₀ to C₃₆-carboxylic acids and the fatty acid esters to be employed according to the invention either are known as such from the literature or may be prepared by processes known from the literature. Examples of pentaerythritol fatty acid esters are those of the particularly preferred above mentioned monocarboxylic acids.

Esters of pentaerythritol and of glycerol with stearic acid and palmitic acid are particularly preferred.

Esters of Guerbet alcohols and of glycerol with stearic acid and palmitic acid and optionally hydroxystearic acid are also particularly preferred.

These esters may be present both in the base and in coextrusion layers optionally present. In this context, various additives and concentrations may be present in each layer. They may be processed with polycarbonates without problems and show no impairments in the shaped articles obtained as the product.

The invention is illustrated further by the following example, but without limiting it.

### EXAMPLES

Polycarbonate sheets with a starting thickness of 980 μm in a width and length of approx. 430 mm of the following materials were used:

### Comparison example

Makrolon® 3103, linear bisphenol A polycarbonate from Bayer AG (Leverkusen, Germany) with an MVR of approx. 6 cm³/10 min and a viscosity parameter of 1.71.

### Example 1

Makrolon® 1243, branched bisphenol A polycarbonate from Bayer AG (Leverkusen, Germany) with an MVR of approx. 6 cm³/10 min and a viscosity parameter of 1.88.

### Example 2

Makrolon® 1143, branched bisphenol A polycarbonate from Bayer AG (Leverkusen, Germany) with an MVR of approx. 3 cm³/10 min and a viscosity parameter of 2.27.

The MVR was determined at 300° C. under a load of 1.2 kg in accordance with ISO 1133. The viscosity parameter was determined by the melt viscosity in Pa*s at a shear rate of 100/s at 300° C. divided by the melt viscosity in Pa*s at a shear rate of 1,000/s at 300° C., in each case measured in accordance with DIN 54811-B.

Forming experiments were carried out on these sheets in the “positive” forming process on a thermoforming installation from Illig, type UA 100, equipped with upper and lower heating, pyrometer and tool temperature control. No “preblasting” with compressed air was carried out, no vacuum was applied after the forming and cooling was carried out without cooling air. The shaping was carried out by mechanical stretching by moving the tool against the preheated sheet to simulate both the corrugating process in corrugated sheet production and the stretching in thermoforming, which represents the process step in which thickness differences chiefly occur.

The thermoforming tool employed was a rectangular punch of aluminium with the following dimensions:

Punch area 195 mm×130 mm

Tool height 100 mm

The forming was carried out at a tool temperature of 90° C., temperature of the upper heating of 450° C., temperature of the lower heating of 390° C. and a surface temperature of the sheet (measured by means of a pyrometer) of 190° C.

After cooling the formed molding was removed from the mold manually and the residual wall thickness was determined at a number of measurement points on the newly formed molding edge and in the middle of the newly formed side region.

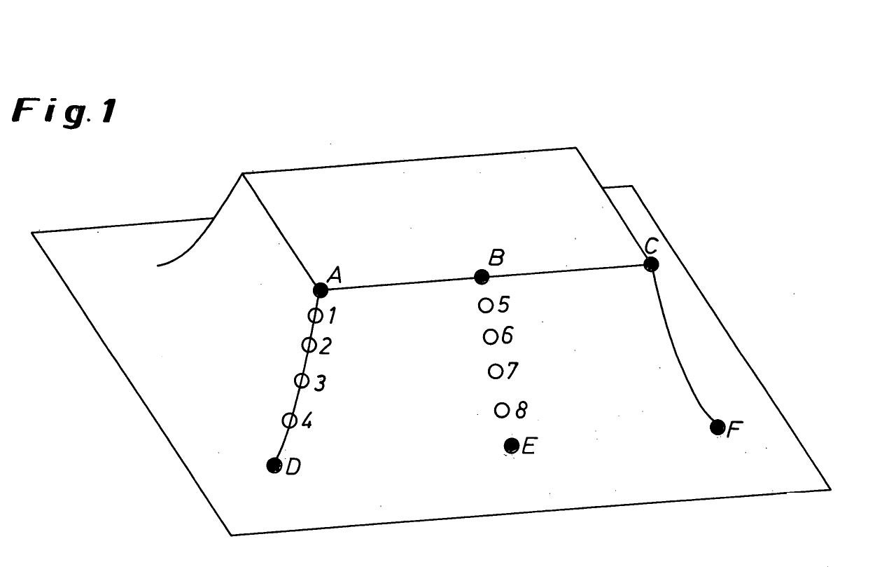

The formed molding is shown in FIG. 1.

In FIG. 1 the points A and C denote the upper comer points of the formed moulding, point B is the middle point of the straight line between points A and C. The points D and F correspondingly designate the lower comer points of the formed moulding and point E the middle point of the straight line between points D and F.

Position of the Measurement Points:

Measurement points 1-4 lie along the edge between points A and D. The distance here of the measurement points from point A is 10 mm for measurement point 1, 30 mm for measurement point 2, 55 mm for measurement point 3 and 85 mm for measurement point 4. Measurement points 5-8 lie along the edge between points B and E. The distance here of the measurement points from point B is 10 mm for measurement point 5, 30 mm for measurement point 6, 55 mm for measurement point 7 and 85 mm for measurement point 8.

Results:

The residual wall thicknesses of the moldings obtained from solid sheets by hot-forming are shown in tables 1 and 2.

TABLE 1
Residual wall thickness in molding corners

| Measurement point | Comparison example | Example 1 | Example 2 |
|---|---|---|---|
| 1 | 0 (formation of holes) | 340 μm | 400 μm |
| 2 | 0 (formation of holes) | 260 μm | 310 μm |
| 3 | 450 μm | 610 μm | 580 μm |
| 4 | 800 μm | 855 μm | 850 μm |

TABLE 2
Residual wall thickness middle side region

| Measurement point | Comparison example | Example 1 | Example 2 |
|---|---|---|---|
| 5 | 420 μm | 500 μm | 475 μm |
| 6 | 355 μm | 370 μm | 375 μm |
| 7 | 540 μm | 550 μm | 550 μm |
| 8 | 805 μm | 805 μm | 805 μm |

The results show that under the same forming conditions the moldings according to the invention thin out to a lesser extent, although the MVR of the materials employed in example 1 and the comparison example is the same. This surprising effect renders possible an advantageous production of moldings by hot-forming. Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermally-formed molded article comprising a branched polycarbonate having a melt volume rate (MVR at 300° C. under a load of 1.2 kg in accordance with ISO 1133) of 1.5 to 10 and a viscosity parameter of 1.75 to 3.0, said branched polycarbonate being the product of a reaction entailing at least one dihydroxy compound and at least one branching agent.

2. The article according to claim 1 wherein the melt volume rate is 2.0 to 8 cm³/10 min.

3. The article according to claim 1 wherein the branching agent is present in the reaction in an amount of 0.05 to 0.6 mol %, based on 100 mol % of dihydroxy compound.

4. The article according to claim 1 wherein the dihydroxy compound is at least one member selected from the group consisting of bisphenol A, bisphenol TMC and 4,4′-dioxydiphenyl.

5. The article of claim 1 in the form of a corrugated sheet.

6. A process for the production of polycarbonate moldings having improved thickness uniformity, comprising the steps of
(i) producing a solid sheet of a branched polycarbonate having melt volume rate (MVR at 300° C. under a load of 1.2 kg in accordance with ISO 1133) of 1.5 to 10 and a viscosity parameter of 1.75 to 3.0,
(ii) heating the sheet to a forming temperature between the glass transition temperature and the conventional extrusion temperature of the polycarbonate, and
(iii) forming the heated sheet at the forming temperature by at least one means selected from the group consisting of mechanical forces, vacuum and compressed air.

7. The process according to claim 6 wherein the forming temperature is 220° C. to 140° C.

8. The process according to claim 6 wherein the forming is carried out in a corrugating device.
